(19) United States
(12) Patent Application Publication
(10) Pub. No.: US 2025/0094104 A1
(43) Pub. Date: Mar. 20, 2025

(54) SYSTEMS AND METHODS FOR PRODUCTION ANALYTICS MONITORING AND MANAGEMENT OF A PRINTING DEVICE

(71) Applicant: Entrust Corporation, Shakopee, MN (US)

(72) Inventors: Brendan Hinnenkamp, Shakopee, MN (US); Joao Matos, Shakopee, MN (US); Rob Wilrett, Shakopee, MN (US); Kent Landerholm, Shakopee, MN (US)

(21) Appl. No.: 18/883,816

(22) Filed: Sep. 12, 2024

Related U.S. Application Data
(60) Provisional application No. 63/583,071, filed on Sep. 15, 2023.

(51) Int. Cl. G06F 3/12

(52) U.S. Cl. CPC G06F 3/1259; G06F 3/1207; G06F 3/121; G06F 3/1222; G06F 3/1285

(57) ABSTRACT

A method of production analytics of a printing architecture that includes one or more printing devices is provided. The method includes an operator management device retrieving printing device output data, supplies data, HSM output data, and printer functionality component data. Also, the method includes the operator management device storing the printing device output data, the supplies data, the HSM output data and the printer functionality component data. The method also includes the operator management device combining the printing device output data, the supplies data, the HSM output data and the printer functionality component data to generate one or more graphs and models regarding an overall health of the printing architecture. The method further includes a fleet management GUI displaying the one or more graphs and models on a display.

This application claims the benefit of U.S. Provisional Application No. 63/583,071, the entire contents of which are incorporated herein by reference.

### FIELD

This disclosure relates to systems and methods for production analytics monitoring and management of a printing architecture that includes one or more printing devices.

### BACKGROUND

Printing devices can be used in the production of a personalization document. Some personalization documents, for example those having a smart chip (e.g., smart cards), may require cryptographic operations and data to be stored therein. One or more hardware security modules (HSMs) may be used to perform the cryptographic operations and/or obtain the cryptographic data. In many instances, these personalization documents are required to be printed in large batches over multiple printing devices. Maintaining and monitoring operation of the printing devices and HSMs is desirable.

### SUMMARY

This disclosure relates to systems and methods for production analytics monitoring and management of a printing architecture that includes one or more printing devices.

In particular, the embodiments described herein are directed to monitoring and managing an overall health of the printing architecture. This can include monitoring and managing one or more supplies, one or more HSMs, and one or more printer functionality components of each of the one or more printing devices. The embodiments described herein can compare two or more of supplies status, HSMs status, printer functionality components status, and printing device(s) output status to obtain an overall health of the one or more printing devices.

In some embodiments, an operator management device can obtain and store current information from each of the one or more printing devices and optionally a cryptographic object management system to track supplies status, HSMs status and printer functionality components status. The operator management device can track the stored information over time to manage the one or more printing devices.

In some embodiments, the operator management device can include a fleet management graphical user interface (GUI). The fleet management GUI can include a dashboard that allows an operator to view, in real time, how each of the printing devices and how each of the HSMs are operating to provide the operator with an overall health of the printing architecture.

In one embodiment, a method for providing production analytics of a printing architecture that includes one or more printing devices is provided. The method can include an operator management device retrieving printing device output data regarding output data from each of the one or more printing devices. The method can also include the operator management device retrieving supplies data regarding supplies used by each of the one or more printing devices. Also, the method can include the operator management device retrieving HSM output data regarding each of a plurality of HSMs of the printing architecture. Further, the method can include the operator management device retrieving printer functionality component data regarding each of a plurality of printer functionality components included in the one or more printing devices. Moreover, the method can include the operator management device storing the printing device output data, the supplies data, the HSM output data and the printer functionality component data. Also, the method can include the operator management device combining the printing device output data, the supplies data, the HSM output data and the printer functionality component data to generate one or more graphs and models regarding an overall health of the printing architecture. The method can also include a fleet management GUI displaying the one or more graphs and models on a display.

In another embodiment, a printing architecture is provided. The architecture can include one or more central card issuance systems each of which configured to produce a plurality of personalization documents. Also, the architecture can include a plurality of HSMs configured to perform a cryptographic operation for at least one of the plurality of personalization documents. The architecture can also include an operator management device that includes a fleet management graphical user interface GUI. The operator management device is configured to retrieve printing device output data regarding output data from each of the one or more central card issuance systems, retrieve supplies data regarding supplies used by each of the one or more central card issuance systems, retrieve HSM output data regarding each of the plurality of HSMs, and retrieve printer functionality component data regarding each of a plurality of printer functionality components included in the one or more central card issuance systems. The operator management device can also be configured to store the printing device output data, the supplies data, the HSM output data and the printer functionality component data. The operator management device can further be configured to combine the printing device output data, the supplies data, the HSM output data and the printer functionality component data to generate one or more graphs and models regarding an overall health of the printing architecture. Also, the fleet management GUI can be configured to display the one or more graphs and models on a display.

In yet another embodiment, a method for providing production analytics of a printing architecture that includes a central card issuance system is provided. The method can include the operator management device retrieving first supply data regarding a supply used by a first printer functionality component of the central card issuance system. The method can also include the operator management device retrieving second supply data regarding a supply used by a second printer functionality component of the central card issuance system. Also, the method can include the operator management device storing the first supply data and the second supply data. Further, the method can include the operator management device combining the first supply data and the second supply data to generate one or more graphs and models regarding an overall health of the printing architecture. Moreover, the method can include a fleet management GUI displaying the one or more graphs and models on a display.

In a further embodiment, a method for providing production analytics of a printing architecture that includes one or more central card issuance systems is provided. The method can include the operator management device retrieving supplies data regarding supplies used by each of the one or more central card issuance systems. Also, the method can include the operator management device retrieving chip programming data of a chip programming component of at least one of the one or more central card issuance systems, the chip programming data including a programming speed of the chip programming component. Further, the method can include the operator management device storing the supplies data and the chip programming data. Moreover, the method can include the operator management device combining the supplies data and the chip programming data to generate one or more graphs and models regarding an overall health of the printing architecture. Also, the method can include a fleet management GUI displaying the one or more graphs and models on a display.

### DRAWINGS

FIG. 1 illustrates a schematic diagram of an exemplary printing architecture configured to allow for monitoring and managing a fleet of printing devices, according to one embodiment.

FIG. 2 illustrates a flowchart of a method for providing production analytics of a printing architecture that includes one or more printing devices, according to one embodiment.

FIGS. 3A-3H illustrate different screenshots of a fleet management GUI, according to one embodiment.

### DETAILED DESCRIPTION

This disclosure relates to systems and methods for production analytics monitoring and management of a printing architecture that includes one or more printing devices.

In particular, the embodiments described herein are directed to monitoring and managing an overall health of the printing architecture. This can include monitoring and managing one or more supplies, one or more hardware security modules (HSMs), and one or more printer functionality components of each of the one or more printing devices. The embodiments described herein can compare two or more of supplies status, HSMs status, printer functionality components, and printing device(s) output to obtain an overall health of the one or more printing devices.

The embodiments described herein can be used for one or more document personalization machines. The types of printing devices and subcomponents of a printing device (hereinafter referred to simply as the printing device) for document personalization can include, for example, a central card issuance system, a desktop card printer, a desktop embosser, a passport system, a desktop laminator, a desktop embosser, a smart card reader, an input and/or output card hopper, etc.

Examples of personalized documents can include, for example, plastic cards (e.g., financial cards including credit and debit cards (e.g., Europay International, Mastercard International, and Visa International (EMV) cards), identification cards, driver's licenses, etc.), passports, etc. The plastic card may be made entirely of plastic, or a combination of plastic and non-plastic materials. In an embodiment, the personalized documents, such as cards like financial cards, may be made entirely of non-plastic materials such as paper or metal. In an embodiment, the personalized documents may be made of a plastic such as polycarbonate, polyvinyl chloride (PVC), polyethylene terephthalate glycol (PETG), and other plastics.

For large volume batch production of personalized documents, institutions often utilize systems that employ multiple processing stations or modules to process multiple documents at the same time to reduce the overall per document processing time. These systems are typically referred to as central issuance systems. Examples of such systems are disclosed in U.S. Pat. Nos. 4,825,054, 5,266,781, 6,783,067, and 6,902,107, all of which are incorporated herein by reference in their entirety. As with desktop document processing machines, batch processing systems also typically include printing and chip programming capabilities.

Card personalization machines can be designed for relatively small scale, individual document personalization and production. In these systems, a single document to be personalized is input into a processing machine, which typically includes one or two personalization/processing capabilities, such as printing and chip programming. These processing machines are often termed desktop processing machines because they have a relatively small footprint intended to permit the processing machine to reside on a desktop. Many examples of desktop processing machines are known, such as the Sigma, CD and Artista lines of desktop card printers available from Entrust Corporation of Shakopee, Minnesota. Other examples of desktop processing machines are disclosed in U.S. Pat. Nos. 7,434,728 and 7,398,972, each of which is incorporated herein by reference in its entirety.

The terms “supply” and “supplies” as described herein can be directed to, for example, a printing ribbon supply, a liquid supply (e.g., ink), a laminate supply, a print foil supply, etc.

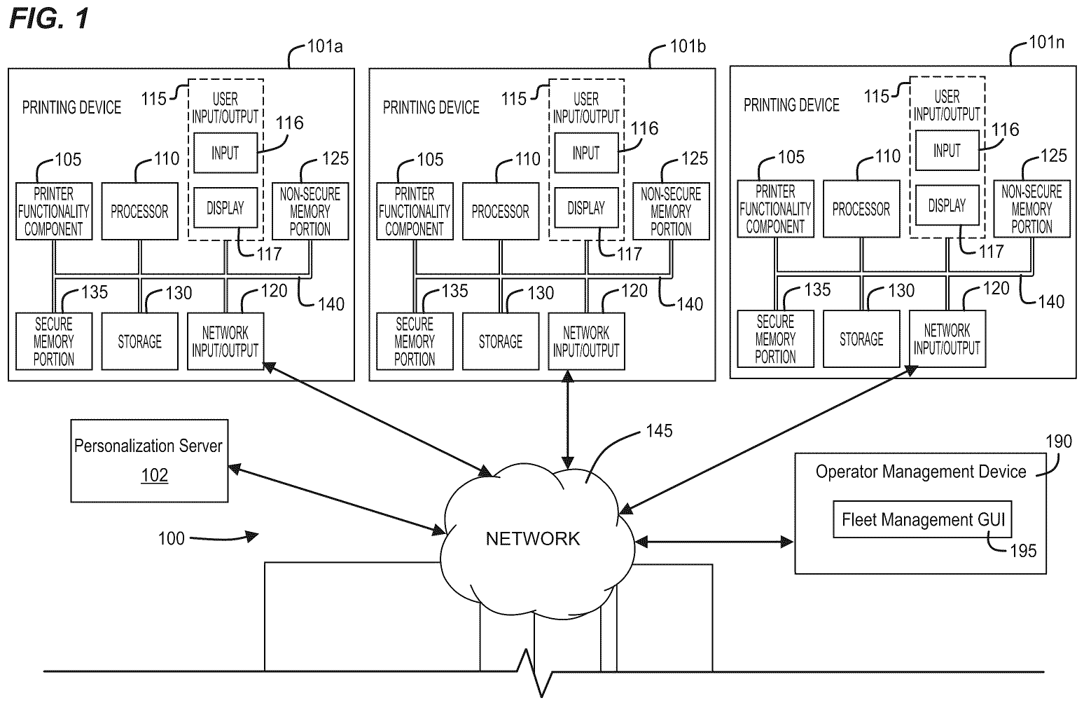

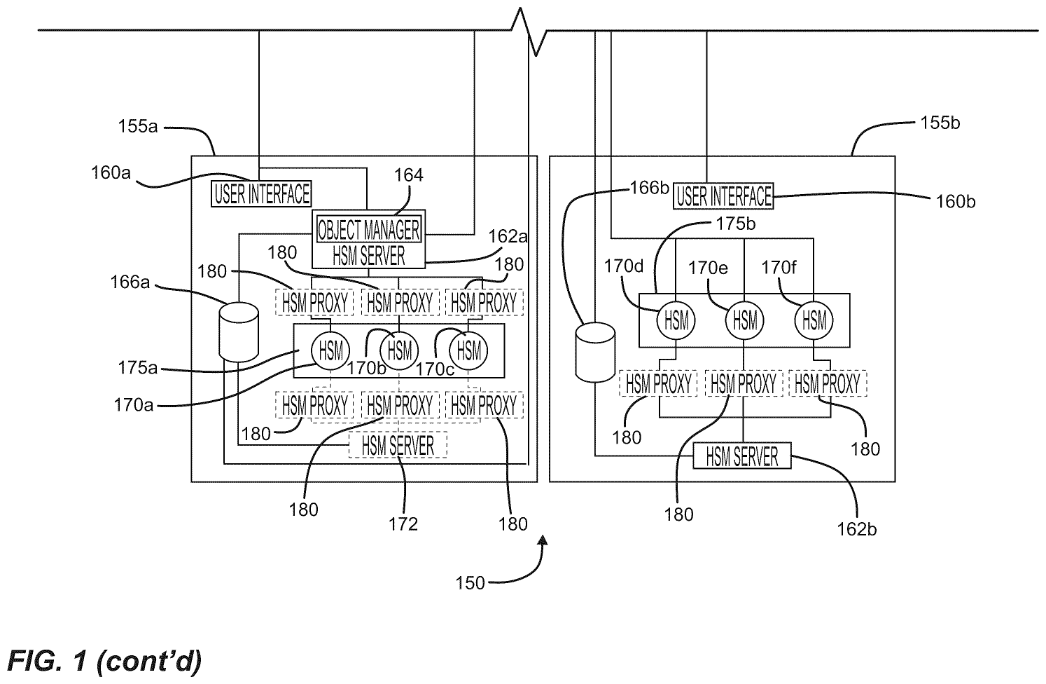

FIG. 1 illustrates a schematic diagram of an exemplary printing architecture 100 configured to allow for monitoring and managing a fleet of printing devices 101a-n, according to one embodiment. The printing architecture 100 includes the fleet of printing devices 101a-n, a personalization server 102, a cryptographic object management system 150, and an operator management device 190 connected via a network 145.

Each of the printing devices 101a-n generally can include one or more printer functionality component(s) 105, a processor 110, an optional user input/output (I/O) 115, a network I/O 120, a non-secure memory portion 125, a storage 130, a secure memory portion 135, and an interconnect 140. Each printing device 101a-n can be in communication with the personalization server 102, the operator management device 190 and the cryptographic object management system 150 through the network 145. It will be appreciated that in other embodiments, each of the printing devices 101 can include one or more of the processor 110, the user (I/O) 115, the network I/O 120, the non-secure memory portion 125, the storage 130, the secure memory portion 135, and the interconnect 140.

The printing devices 101a-n are generally representative of hardware aspects of a variety of printing devices and subcomponents that can be used in the issuance of a customized personalization document. Examples of the printing devices 101a-n can include a distributed issuance printer, a central card issuance system, a desktop card printer, a desktop embosser, a passport system, a desktop laminator, a smart card reader, an input and/or output card hopper, etc. It will be appreciated that the examples of the printing devices 101a-n listed above are exemplary and other types of printing devices can also be included.

The one or more printer functionality components 105 can perform one or more primary functions of the printing devices 101. For example, when the printing devices 101 is a central card issuance system, the printer functionality component 105 can be: a printer that is configured to print a card; a desktop embosser that is configured to emboss a card; a laminator that is configured to laminate a card; a magnetic stripe station that is configured to read and/or write data to a magnetic stripe; a chip programming station that is configured to read data on a chip and/or write data to a chip; etc. In some embodiments, the chip programming station can read data and/or write data on two or more chips of two or more cards simultaneously. In some embodiments, each of the one or more printer functionality components 105 can be an internal hardware component of the printing device 101.

At least one or more of the printer functionality components 105 are configured to use a supply to perform a primary function of the printing device 101. In some embodiments, the supply can be a ribbon supply, an ink supply, etc. Examples of a printer functionality component 105 that uses a ribbon supply can include, for example, Artista® VHD Retransfer Printing Module, CardCleaner, CardGard® printing module, DuraGard® printing module, D2T2Color printing module, D2T2ColorYMC printing module, Graphics printing module, Graphics3 printing module, Durable Graphics Printing module, Topcoat printing module, Topper printing module, SecureIndent printing module provided by Entrust Corporation of Shakopee, Minnesota. Examples of a printer functionality component 105 that uses an ink supply can include, for example, a Drop-On-Demand Inkjet printing module.

The processor 110 controls operation of the printing devices 101 including the printer functionality component 105, the network I/O 120 and the optional user I/O 115. The processor 110 can retrieve and execute programming data obtained by the network I/O 120 and/or the optional user I/O 115 and stored in the non-secure memory portion 125, the secure memory portion 135 and/or the storage 130. The processor 110 can also store, identify and use application data residing in the non-secure memory portion 125.

The interconnect 140 is used to transmit programming instructions and/or application data between the processor 110, the one or more printer functionality components 105, the optional user I/O 115, the network I/O 120, the non-secure memory portion 125, the storage 130, and the secure memory portion 135. The interconnect 140 can, for example, be one or more busses or the like. The processor 110 can be a single processor, multiple processors, or a single processor having multiple processing cores.

The optional user I/O 115 can include an input 116 and/or a display 117, according to some embodiments. It is to be appreciated that the optional user I/O 115 can be one or more devices connected in communication with the printing devices 101 that is physically separate from the printing devices 101. For example, the input 116 and the display 117 can be connected in communication but be physically separate from the printing devices 101. In some embodiments, the input 116 and the display 117 can be physically included with the printing devices 101.

The display 117 can include any of a variety of display devices suitable for displaying information to the user. Examples of devices suitable for the display 117 include, but are not limited to, a cathode ray tube (CRT) monitor, a liquid crystal display (LCD) monitor, a light emitting diode (LED) monitor, or the like.

The input 116 can include any of a variety of input devices or means suitable for receiving an input from the user. Examples of devices suitable for the input 116 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 116 can be included as the input 116. In some embodiments, the input 116 can be integrated with the display 117 such that both input and output are performed by the display 117.

The network I/O 120 is configured to transmit data to and receive data from the personalization server 102, the operator management device 190 and the cryptographic object management system 150 via the network 145. In some embodiments, the network I/O 120 can communicate, via the personalization server 102, with the cryptographic object management system 150 to request one or more of HSMs 170 to perform a cryptographic operation and receive the results of the cryptographic operation.

The non-secure memory portion 125 is generally included to be representative of a random access memory such as, but not limited to, Static Random Access Memory (SRAM), Dynamic Random Access Memory (DRAM), or Flash. In some embodiments, the non-secure memory portion 125 can be a volatile memory. In some embodiments, the non-secure memory portion 125 can be a non-volatile memory. In some embodiments, at least a portion of the memory can be virtual memory.

The storage 130 is generally included to be representative of a non-volatile memory such as, but not limited to, a hard disk drive, a solid-state device, removable memory cards, optical storage, flash memory devices, network attached storage (NAS), or connections to storage area network (SAN) devices, or other similar devices that may store non-volatile data. In some embodiments, the storage 130 is a computer readable medium. In some embodiments, the storage 130 can include storage that is external to the printing devices 101, such as in a cloud.

The secure memory portion 135 is generally included to be representative of a memory storage device that is distinct and/or separate from the non-secure memory portion 125 and the storage 130. In some embodiments, the secure memory portion 135 includes a processor. The secure memory portion 135 can include for example, a secure crypto processor such as a TPM, a JAVA card, a memory device, etc. Suitable TPMs are sold by Infineon Technologies AG (Munich, Germany). In some embodiments, the secure memory portion 135 includes the capabilities for the secure generation of cryptographic keys. In some embodiments, private keys used in the secure memory portion 135 are not accessible on a bus or to external programs and all encryption/decryption is done within the secure memory portion 135. In some embodiments, the secure memory portion 135 can include one or more HSMs.

In some embodiments, the secure memory portion 135 can be part of the same memory device as the non-secure memory portion 125 and/or the storage 130, but isolated from the non-secure memory portion 125 and/or the storage 130.

In some embodiments, the secure memory portion 135 is configured to store a plurality of private keys that help form a unique and secure identity of the printing devices 101. Each of the private keys can be associated with a different operation of the printing devices 101. In some embodiments, the printing devices 101 can be issued one or more certificates by a Central Authority (CA) such as, for example, a manufacturing CA with any corresponding private keys stored in the secure memory portion 135.

Authorization of a particular operation of the printing devices 101 can be established using the particular private key associated with the particular operation.

Each of the printing devices 101a-n is configured to communicate with the personalization server 102. In some embodiments, the printing devices 101a-n can also be configured to communicate with the cryptographic object management system 150.

The personalization server 102 can be a hardware and/or software system that is configured to provide personalization data to the printing devices 101. In some embodiments, the personalization server 102 can communicate directly with the cryptographic object management system 150 and provide cryptographic data from the cryptographic object management system 150 to any of the printing devices 101.

The cryptographic object management system 150 is configured to perform one or more cryptographic operations. The cryptographic object management system 150 includes a plurality of object management sites 155 that are connected via the network 145. The embodiment shown in FIG. 1 shows a primary object management site 155a and a secondary object management site 155b. In other embodiments, the cryptographic object management site 150 include a single object management site 155 or three or more object management sites. While the printing architecture 100 shown in FIG. 1 includes a single cryptographic object management site 150, in other embodiments the printing architecture 100 can include two or more independent cryptographic object management sites 150.

The primary object management site 155a and the secondary object management site 155b can be at physically separate locations and can be configured to operate independently. It will be appreciated that in other embodiments, the cryptographic object management system 150 can include only a single object management site 155 or three or more object management sites 155. In some embodiments, either of the object management sites 155a, 155b can be used to help the printing devices 101a-n produce a secure document such as a financial document (e.g., an EMV document), a driver's license, a passport, etc. In some embodiments, an operator can choose, via the operator management device 190 whether the primary object management site 155a or the secondary object management site 155b is to be used.

The primary object management site 155a includes an object management user interface 160a, a primary site HSM server 162a with an object manager module 164, a persistent layer 166a, and a plurality of HSMs 170a-c. In some embodiments, the primary object management site 155a can also include one or more optional HSM servers 172. The plurality of HSMs 170a-c is grouped together into a primary load balancing pool 175a. The secondary object management site 155b includes an object management user interface 160b, a secondary site HSM server 162b, a persistent layer 166b, and a plurality of HSMs 170d-f. The plurality of HSMs 170d-f is grouped together into a secondary load balancing pool 175b. It will be appreciated that the total number of HSMs 170 can vary. For example, in one embodiment, the cryptographic object management system 150 can include only a single HSM 170. In other embodiments, the cryptographic object management system 150 can include three or more HSMs 170. Also, the number of HSMs 170 in each of the load balancing pools 175a, 175b can vary. For example, in one embodiment, the load balancing pool 175a or the load balancing pool 175b can include only a single HSM 170. In other embodiments, the load balancing pool 175a or the load balancing pool 175b can include three or more HSMs 170. Also, the cryptographic object management system 150 can include only one load balancing pool 175 or three or more load balancing pools 175.

As shown in FIG. 1, the object management user interfaces 160a, 160b can communicate with the object manager module 164 and can provide redundant access and management of cryptographic objects that are available to both of the object management sites 155a, 155b. In some embodiments, the object management user interface 160a can be configured to allow an operator to control and manage the primary object management site 155a. Also, in some embodiments, the object management user interface 160b can be configured to allow an operator to control and manage the secondary object management site 155b. In some embodiments, the object management user interfaces 160a, 160b can be a user interface accessed through, for example, a web browser. In some embodiments, the user interfaces 160a, 160b can allow an operator to view information about a selected HSM 170 (e.g., firmware version, model number, etc.).

The HSM servers 162 are connected to the plurality of HSMs 170. The primary HSM server 162a is connected to the HSMs 170a-c that are part of the load balancing pool 175a. In some embodiments, the primary HSM server 162a (and the optional HSM server 172) is connected to the HSMs 170a-c via optional HSM proxies 180. The secondary HSM server 162b is connected to the HSMs 170d-f that are part of the load balancing pool 175b. In some embodiments, the secondary server 162b is connected to the HSMs 170d-f via optional HSM proxies 180. Each of the HSM proxies 180 can be responsible for handling communication with one HSM of the plurality of HSMs 170. This can allow the HSM proxies 180 to reconnect with a particular HSM 170 without interfering with the use of the other HSMs 170. The primary site HSM server 162a is configured to manage and control operation of the HSMs 170a-c. In some embodiments, any of the HSM servers 162, 172 can be a software application. In some embodiments, any of the HSM servers 162, 172 can be a hardware device. In yet some other embodiments, any of the HSM servers 162, 172 can be a combination of a hardware device and a software application. In some embodiments, the cryptographic object management system 150 may not include any HSM servers. In other embodiments, the cryptographic object management system 150 can include any number of HSM servers as required.

The object manager module 164 of the primary site HSM server 162a is configured to manage and control the cryptographic object management system 150. In some embodiments, the object manager module 164 is a software application operated by the primary site HSM server 162a. In other embodiments, the object manager module 164 can be a hardware device that is part of the HSM server 162a. The object manager module 164 is connected to the object management user interfaces 160a, 160b. In some embodiments, the object manager module 164 can be used to assist in managing the issuance of a secure document including, for example, a financial document, a driver's license, a passport, etc.

The object manager module 164 can communicate with and manage the HSMs 170a-c of the primary object management site 155a and communicate with and manage the HSMs 170d-f of the secondary object management site 155b. The object manager module 164 can introduce and manage cryptographic objects to be used in the cryptographic object management system 150. The object manager module 164 can introduce cryptographic objects by instructing one or more of the plurality of HSMs 170 to generate a new cryptographic object for the HSM 170. The object manager module 164 can also add or remove one or more HSMs 170 to one of the object management sites 155.

The object manager module 164 can communicate with the printing devices 101, via the personalization server 102, to provide cryptographic operations and calculations that can be used in producing personalization documents.

The object manager module 164 can also provide maintenance to the HSMs 170, update firmware of each of the HSMs 170, and can add or remove one or more HSMs 170 to either of the object management sites 155a, 155b. In some embodiments, the object manager 164 can perform maintenance on one or more of the plurality of HSMs 170 while the remaining HSMs 170 are performing production/issuance activities.

In some embodiments, the object manager 164 can be bundled with one or more files having HSM firmware and certificate(s). This can improve usability and integrity of the cryptographic object management system 150 by allowing the appropriate file for a specific type or a particular HSM 170 to be automatically selected. Accordingly, an operator is not required to browse two or more file locations and select a version of a file appropriate for the specific type of or a particular HSM 170.

The persistent layers 166a, 166b are configured to store cryptographic objects typically stored in the HSMs 170. The persistent layers 166a, 166b can be, for example, a network storage device, a database, etc. A cryptographic object can include, for example, a cryptographic token, a cryptographic secret key, a cryptographic public key, a cryptographic private key, a cryptographic certificate, a decimalization table, a weak PIN list, operator group lists, etc. The cryptographic objects stored in the persistent layers 166a, 166b (also referred to as persisted cryptographic objects) are encrypted. In some embodiments, the cryptographic objects can be stored in the persistent layers 166a, 166b as cryptograms. During operation of the cryptographic object management system 150, when a cryptographic object is required by one of the HSMs 170a-c, the persistent layer 166a is configured to provide the cryptographic object to the particular HSM 170a-c via the primary site HSM server 162a. Similarly, when a cryptographic object is required by one of the HSMs 170d-f, the persistent layer 166b is configured to provide the cryptographic object to the particular HSM 170d-f via the secondary site HSM server 162b.

The persistent layers 166a, 166b are also connected via the network 145. During operation of the cryptographic object management system 150, the persistent layers 166a, 166b can communicate to provide automatic replication of the persistent layers 166a, 166b. Accordingly, any addition of, removal of, or change made to a cryptographic object in the persistent layer 166a can be automatically replicated in the persistent layer 166b and vice versa. In some embodiments, the persistent layers 166a, 166b can undergo a complete automatic replication process. In other embodiments, the persistent layers 166a, 166b can undergo a partial automatic replication process as required by the cryptographic object management system 150. For example, it may be desirable to make only some of the cryptographic objects stored in persistent layer 166a available at site 155b. In these embodiments, a portion of the information stored in persistent layer 166a can be replicated and stored in persistent layer 166b. By making cryptographic objects available to each of the persistent layers 166a, 166b, the cryptographic object management system 150 can help meet disaster recovery requirements when one of the primary object management site 155a or the secondary object management site 155b is not working (e.g., during a power outage, routine maintenance, loss of network, natural or man-made disaster, etc.).

The plurality of HSMs 170 are configured to provide crypto-processing of cryptographic objects stored in the persistent layers 166a, 166b. Each of the HSMs 170 has a finite storage space. By storing the cryptographic objects in the persistent layers 166a, 166b rather than in the HSMs 170, the HSMs 170 can avoid running into storage capacity issues. The plurality of HSMs 170a-c share the persistent layer 166a and the plurality of HSMs 170d-f share the persistent layer 166b. It will be appreciated that in some embodiments, one or more of the HSMs 170 can be configured to store cryptographic data in its storage space. In some embodiments, data stored in one or more of the persistent layers 166a, 166b can also be stored in one or more of the HSMs 170, and vice versa. Accordingly, the plurality of HSMs 170 can provide crypto-processing while not being required to provide persistent storage of cryptographic objects.

Also, any change to, addition or removal of a cryptographic object stored in one of the persistent layers 166a, 166b by the object manager module 164 results in the cryptographic object being automatically updated for each of the HSMs 170. That is, each of the HSMs 170 can have an automatic and real-time access to each of the cryptographic objects that have been added or updated to the persistent layers 166a, 166b. Accordingly, each of the HSMs 170 does not need to be updated when a cryptographic object is edited, added, or removed.

In some embodiments, one or more of the plurality of HSMs 170 can be placed in a maintenance mode whereby the HSM 170 remains connected to one of the HSM servers 162,172 but is not used for production/issuance activities. Accordingly, the cryptographic object management system 150 can perform functions on one or more of the HSMs 170 (e.g., updating firmware, etc.) without having to stop production/issuance of the system 150. That is, even when one or more of the HSMs 170 are in maintenance mode, the remaining HSMs 170 can be operated as needed for production/issuance activities.

In some embodiments, one or more of the HSMs 170 can generate a cryptographic secret key and can export two or more components that form the cryptographic secret key outside of the HSM 170 while meeting industry specifications (e.g., Payment Card Industry (PCI) specifications). The cryptographic object management system 150 can also allow one or more of the HSMs 170 to receive the two or more components that form cryptographic private key and to combine the two or more components to obtain the cryptographic secret key while meeting industry specifications. In some embodiments, a device that may have no memory or internal processing (e.g., a dumb terminal) can be connected directly to one or more of the HSMs 170 to allow the HSM 170 to export the one or more components that form the cryptographic private key and to receive the one or more components that form the cryptographic private key. In some of these embodiments, an operator can specify the particular HSM 170 (e.g., the HSM 170 that is connected to a dumb terminal) to export or receive the one or more components that form the cryptographic private key.

In some embodiments, each of the HSM(s) 170 can include for example, a secure crypto processor such as a TPM, a JAVA card, a memory device, etc. In some embodiments, each of the HSM(s) 170 can be configured to store one or more certificates, one or more public keys, one or more private keys, an attestation identity key, and/or a storage root key associated with the one or more printing devices 101. In some embodiments, one or more of the HSM(s) 170 can work in conjunction with and/or in lieu of the secure memory portion 135 of the printing device 101.

The load balancing pools 175 allow configuration of affinity between printing device 101 (or an intermediate process) and a particular set of HSMs of the plurality of HSMs 170. Accordingly, activity of the HSMs 170 can be segregated based on, for example, processing demand, network topology, maintenance needs, etc. The load balancing pools 175 can reduce lag time when multiple cryptographic objects are requested by the object manager module 164. For example, the HSM server 162a and the optional HSM server 172 can choose which of the HSMs 170a-c is used for providing crypto-processing of each of the requested cryptographic objects stored in the persistent layer 166a. Similarly, the HSM server 162b can choose which of the HSMs 170d-f is used for providing crypto-processing of each of the requested cryptographic objects stored in the persistent layer 166b. By balancing the load on each of the HSMs 170 within each of the load balancing pool 175a, 175b, geographic affinity can be improved and latency within the cryptographic object management system 150 can be reduced. In some embodiments, either or both of the object management sites 155a, 155b can include multiple load balancing pools 175 that group different HSMs 170 within the particular object management site 155.

The optional HSM server 172 can be deployed to provide redundancy within the cryptographic object management system 150. It will be appreciated that each of the HSM servers 162a, 162b and optional HSM server 172 is configured to work with a particular load balancing pool 175. For example, the HSM server 162a works with the load balancing pool 175a. Also, both the HSM server 162b and the optional HSM server 172 works with the load balancing pool 175b. That is, the number of HSM servers 162a, 162b, 172 is equal to or greater than the number of load balancing pools 175.

In some embodiments, the cryptographic object management system 150 can be used in conjunction with, for example, a financial document issuance system that allows an operator to issue and produce financial cards such as, for example, EMV cards.

The network 145 may alternatively be referred to as the communications network 145. Examples of the network 145 can include, but are not limited to, a local area network (LAN), a wide area network (WAN), the Internet, a wired communication link, or the like. In some embodiments, the personalization server 102, the network I/O 120, the object management user interfaces 155, the object manager module 164, and the persistent layers 166 can securely transmit and receive data via the network 145 through a wireless connection using WiFi, Bluetooth, ZigBee or other similar wireless communication protocols. In some embodiments, the printing devices 101a-n can transmit data via the network 145 through a cellular, 3G, 4G, or other wireless protocol. In some embodiments, the personalization server 102 can transmit data via the network 145 through a cellular, 3G, 4G, or other wireless protocol. In some embodiments, the object management user interfaces 160, the object manager module 164, and the persistent layers 166 can securely transmit and receive data via the network 145 through a cellular, 3G, 4G, or other wireless protocol. In some embodiments, the personalization server 102, the network I/O 120, the object management user interfaces 160, the object manager module 164, and the persistent layers 166 can securely transmit and receive data via a wire line, an optical fiber cable, a Universal Serial Bus “USB” cable, or the like. It is to be appreciated that the personalization server 102, the network I/O 120, the object management user interfaces 160, the object manager module 164, and the persistent layers 166 can securely communicate through the network 145 through suitable combinations of the preceding wired and wireless communication methods. In some embodiments, communication between the personalization server 102, the network I/O 120, the object management user interfaces 160, the HSM servers 162, the object manager module 164, the persistent layers 166, the HSMs 170, the optional HSM server 172 and the optional HSM proxies 180 can be performed using hypertext transfer protocol (HTTP) or a hypertext transfer protocol secure (HTTPS). It is to be appreciated that the personalization server 102, the network I/O 120, the object management user interfaces 160, the HSM servers 162, the object manager module 164, the persistent layers 166, the HSMs 170, the optional HSM server 172 and the optional HSM proxies 180 can communicate through the network 145 through suitable combinations of the preceding wired and wireless communication methods.

The operator management device 190 is configured to monitor and manage the printing devices 101 and the cryptographic object management system 150. In particular, the operator management device 190 is configured to communicate, via the network 145, to the network input/output 120 of each of the printing devices 101 to retrieve and store: printing device output data regarding, for example, each of the printing devices 101; supplies data regarding, for example, a supply for each of the printer functionality components 105, and printer functionality component data regarding, for example, each of the printer functionality components 105. The operator management device 190 is also configured to communicate, via the network 145, to one of the HSM servers 162a, 162b, 172 of the cryptographic object management system 150 to retrieve HSM output data regarding, for example, each of the HSMs 170, each of the load balancing pools 175, etc. In some embodiments, the operator management device 190 can be updated with a schedule of print jobs for each of the printing devices 101.

In some embodiments, the operator management device 190 can be located at the same location as the one or more printing devices 101. In some embodiments, the operator management device 190 can be located at a remote location away from the one or more printing devices 101.

In some embodiments, the printing device output data can include data regarding each of the printing devices 101. This can include (for each of the printing devices 101): how many personalization documents are being produced for a particular job; what type of personalization document is being produced; what printer functionality components 105 are being used; the status of the printing device 101; a state of the current job; a job identification of the current running job; a name of the current running job; the number of personalization documents being produced in the current running job; the number of personalization documents produced from the running job at the time of a printing device state change; a number of forms in the current running job; the number of forms produced from the running job at the time of a printing device state change; the amount of time since the last reported statistic; the state of the printing device when the last statistic was reported; a cause of a pause when the printing device state is paused; job run duration; time between job runs; total number of personalization documents produced during the job run; total number of rejected personalization documents during the job run; average throughput; maximum throughput of the printing device during the job run; theoretical maximum throughput supported by the printing device; measured performance of the job run; total time a job is paused during the job run; number of occurrences of the job run being paused for less than five minutes; number of occurrences of the job run being paused for greater than five minutes; etc. The status of the printing device 101 can include, for example, online, idle, starting, running, pausing, paused, resuming, stopping, disconnected, unknown, etc. It will be appreciated that each of the printing devices 101 can send printing device output data to the operator management device 190 in near real time while production is occurring.

In some embodiments, the supplies data can include data regarding supplies used for each of the printing devices 101. This can include (for each of the printing devices 101): a supply level percentage; a percentage change in supply since a last detected supply level change; a percentage change in supply between the last supply level change and a change to a new supply; a current supply level for each of the printer functionality components 105; how much supply is being used for each personalization document; amount of supply wastage between each personalization document being produced; supply level when the supply was removed from the printing device; supply status (e.g., supply removed from printing device, new supply added to printing device); etc. In some embodiments, determining how much supply is being used for each personalization document and determining supply wastage can be calculated by tracking how many personalization documents are being produced for each percentage of supply used. It will be appreciated that each of the printing devices 101 can send supplies data to the operator management device 190 in near real time while production is occurring.

In some embodiments, the printer functionality component data can include data regarding performance status of each of the printer functionality components 105. This can include (for each of the printing devices 101): performance and status data for each of the printer functionality components 105; how many personalization documents have passed through each of the printer functionality components 105; failure data for each of the plurality of printer functionality components 105; physical number of smart card modules; physical number of chip programming stations; chip operation status; time when chip programming started; time when chip programming finished; duration of chip programming from start to end; time spent transmitting and processing chip commands; number of personalization documents in a printer functionality component when a personalization document is processed; time when a personalization document entered the printer functionality component; time when the personalization operation is completed by the printer functionality component; time when the printer functionality component is done with the personalization document; time when the personalization document is ejected from the printer functionality component; etc. In some embodiments, the printer functionality component data can be data regarding a subcomponent of the printer functionality component 105. For example, if the printer functionality component 105 is a print head with one or more heating elements, the network input/output 120 can provide performance and status data of each of the heating elements. It will be appreciated that each of the printing devices 101 can send printer functionality component data to the operator management device 190 in near real time while production is occurring.

In some embodiments, the HSM output data can include data regarding each of the HSMs 170, HSM Servers 162/172 and/or each of the load balancing pools 175. This can include: performance and status data for each of the HSMs 170 and/or HSM Servers 162/172; availability data for each of the HSMs 170 and/or HSM Servers 162/172; a percentage load on each of the HSMs 170 and/or HSM Servers 162/172; a response time (e.g., speed) of each of the HSMs 170; identification of the HSMs 170 in each of the load balancing pools 175; the number of HSMs 170 in each of the load balancing pools 175; the percentage load of each of the load balancing pools 175; amount of time per HSM operation; minimum amount of time taken per HSM operation; maximum amount of time taken per HSM operation; average amount of time taken per HSM operation; performance and frequency data for granular, individual categories of cryptographic commands per HSM 170 and/or HSM Server 162/172 etc. It will be appreciated that cryptographic object management system 150 can send HSM output data to the operator management device 190 in near real time while production is occurring.

The operator management device 190 includes a fleet management GUI 195 that is configured to display information regarding various aspects of the printing devices 101 and the cryptographic object management system 150. In some embodiments, the fleet management GUI 195 includes a dashboard that allows an operator to view, in real time, how each of the printing devices 101 and how each of the HSMs 170 are operating to provide the operator with an overall health of the printing architecture 100. In some embodiments, the fleet management GUI 195 can be a browser-based GUI accessible to the operator via the operator management device 190. In some embodiments, the operator management device 190 can be part of the printing device 101 (for example, when the printing device 101 is a central card issuance system) and the fleet management GUI 195 can be displayed on the display 117.

In some embodiments, the fleet management GUI 195 can use the printing device output data, the supplies data, the HSM output data, and the printer functionality component data obtained by the operator management device 190 and can display the data in various graphs and models to provide the operator an overall view of the health of the printing architecture 100. Based on the displayed data, an operator can draw correlations regarding the overall health of the printing architecture 100. For example, an operator can view displayed data regarding two or more of the printing device output data, the supplies data, the printer functionality component data, and HSM output data to determine an overall health of the printing architecture 100.

In some embodiments, the fleet management GUI 195 can use the printing device output data to display graphs and models tracking operation (e.g., availability, performance, etc.) of each of the printing devices 101. For example, the fleet management GUI 195 can display a current view indicating an online or offline status of each of the printing devices 101, how many personalization documents are being produced by each of the printing devices 101 for a particular job, what type of personalization document is being created by each of the printing devices 101, a response time for producing the personalization document for each of the printing devices 101, the number of personalization documents rejected by the printing devices 101 as unusable, an availability percentage of each of the printing devices 101, a performance percentage of each of the printing devices 101, a quality percentage of each of the printing devices 101, total number of personalization documents produced by each of the printing devices 101, a production time for producing the personalization documents for each of the printing devices 101, a production rate (e.g., personalization documents per hour) for each of the printing devices 101, a production rate (e.g., personalization documents per hour) for the printing architecture 100, an availability percentage of each of the printing devices 101, a performance percentage of the printing architecture 100, a quality percentage of the printing architecture 100, total number of personalization documents produced by the printing architecture 100, a printing device status for each of the printing devices 101, a production progress (e.g., cumulative total, hourly total, etc.) of the printing architecture 100, an hourly output of personalization documents produced by the printing architecture 100, a number of personalization documents produced by personalization document setup, a number of personalization documents produced by job setup, an operational comparison of different personalization document setups and operators based on a quality percentage, total personalization document production, a personalization document production time, a personalization document production rate, a number of rejected personalization documents (e.g., by printer functionality component, by printing device 101, by printing architecture 100, etc.), etc. In some embodiments, the fleet management GUI 195 can use the printing device output data to display a detailed breakdown of any errors on any of the printing devices 101 (e.g., the number of errors, what kind of error occurred, which printing device 101 incurred the error, etc.)

In some embodiments, the fleet management GUI 195 can use the printing device output data and the supplies data to display graphs and models tracking supply levels of various printer functionality components 105 from each of the printing devices 101. For example, the fleet management GUI 195 can display a current view indicating current supply levels of each of the printer functionality components 105, what type of supply is currently on each of the printer functionality components 105, and which of the supplies may be currently at or below a low-level threshold. In another example, the fleet management GUI 195 can display a historical view indicating how much supply has been used for each of the printer functionality components 105 over a set time period (e.g., the last week, the last month, the last six months, the last year, etc.), how much supply was used for each type of personalization document produced, how much supply material is applied to each personalization document, a wastage amount indicating how much material was left on each supply when switched out, a wastage amount indicating how much material is wasted in between producing each personalization document, etc. In some embodiments, the fleet management GUI 195 can use the printing device output data and the supplies data to display a detailed breakdown of when each supply was removed from a printer functionality component 105 (e.g., when the supply was removed, who removed the supply, a percentage of material left on the supply when removed, etc.).

In some embodiments, the fleet management GUI 195 can use the printing device output data and the printer functionality component data to display graphs and models tracking operation (e.g., availability, performance, etc.) of each of the printer functionality components 105. For example, the fleet management GUI 195 can display an online or offline status of each of the printer functionality components 105, a percentage load on each of the printer functionality components 105, a response time (e.g., speed) of each of the printer functionality components 105, an output of each of the printer functionality components 105, a comparison of usage across different printer functionality components 105, etc. In some embodiments, the fleet management GUI 195 can use the printing functionality component data to display a detailed breakdown of any errors on any of the printer functionality components 105 (e.g., the number of errors, what kind of error occurred, which printer functionality component 105 incurred the error, etc.)

In some embodiments, the fleet management GUI 195 can use the printing device output data and the HSM output data to display graphs and models tracking operation (e.g., availability, performance, etc.) of each of the HSMs 170, HSM Servers 162/172 and/or the load balancing pools 175. For example, the fleet management GUI 195 can display an online or offline status of each of the HSMs 170 and/or HSM Servers 162/172, a percentage load on each of the HSMs 170, HSM Servers 162/172 and/or load balancing pools 175, a response time (e.g., speed) of each of the HSMs 170, HSM Server 162/172 and/or load balancing pools 175, a comparison of usage across different HSMs 170, HSM Servers 162/172 and/or across different load balancing pools 175, etc. In some embodiments, the fleet management GUI 195 can use the HSM output data to display a detailed breakdown of any errors on any of the HSMs 170, HSM Servers 162/172 and/or load balancing pools 175 (e.g., the number of errors, what kind of error occurred, which HSM 170, HSM Server 162/172 or load balancing pool 175 incurred the error; performance and frequency data for granular, individual categories of cryptographic commands pers HSM 170 and/or HSM Servers 162/172, etc.)

Optionally, any of these examples described above can be displayed as a graph or model over time to monitor changes in operation (e.g., availability, performance, etc.) over a set time period (e.g., the last week, the last month, the last six months, the last year, etc.) or a desired time interval (e.g., between date x and date y; etc.).

In some embodiments, the fleet management GUI 195 can display various alerts or warnings based on the printing device output data, the supplies data, the HSM output data, and the printer functionality component data obtained by the operator management device 190. In particular, as the operator management device 190 tracks the printing device output data, the supplies data, the HSM output data, and the printer functionality component data, the fleet management GUI 195 can display an alert or warning to the operator indicating an action may be required. For example, the fleet management GUI 195 can display an alert or warning indicating that: one or more of the printing devices 101, the printer functionality components 105, the HSMs 170, HSM Servers 162/172 and/or the load balancing pools 175 is faulty or not operating properly; number of personalization documents being produced is lower than an expected value; one or more of the printer functionality components 105 is low on supply; one or more of the printing devices 101, the printer functionality components 105, the HSMs 170, HSM Servers 162/172 are operating below a desired percentage load threshold; one or more of the HSMs 170 should be reassigned to another load balancing pool 175; one or more of the printing devices 101, the printer functionality components 105, the HSMs 170 is approaching or operating past a warranty level, a recommended life and/or require replacement; etc.

In some embodiments, the operator management device 190 and the fleet management GUI 195 can communicate with an inventory management system and/or a HSM management system. In these embodiments, the operator management device 190 can automatically instruct the inventory management system to, for example, reload new personalization documents for printing when, for example, an input hopper is empty, replace one or more supplies, etc. Also, in these embodiments, the operator management device 190 can automatically instruct the HSM management system to, for example, replace, add, or remove one or more HSMs.

In some embodiments, the operator management device 190 and/or the fleet management GUI 195 can communicate with the object manager module 164 to automatically reconfigure the HSMs 170, HSM Servers 162/172 and or the load balancing pools 175. For example, the operator management device 190 and/or the fleet management GUI 195 can use the printing device output data, the supplies data, the HSM output data, and/or the printer functionality component data to determine how each of the HSMs 170, HSM Servers 162/172 and the load balancing pools 175 should be used. The operator management device 190 and/or the fleet management GUI 195 can then instruct the object manager module 164 how to manage the HSMs 170 and the load balancing pools 175 based on the determination. This can include, for example, changing an online or offline status of one or more of the HSMs 170, moving one or more of the HSMs from one load balancing pool 175 to another load balancing pool 175, etc.

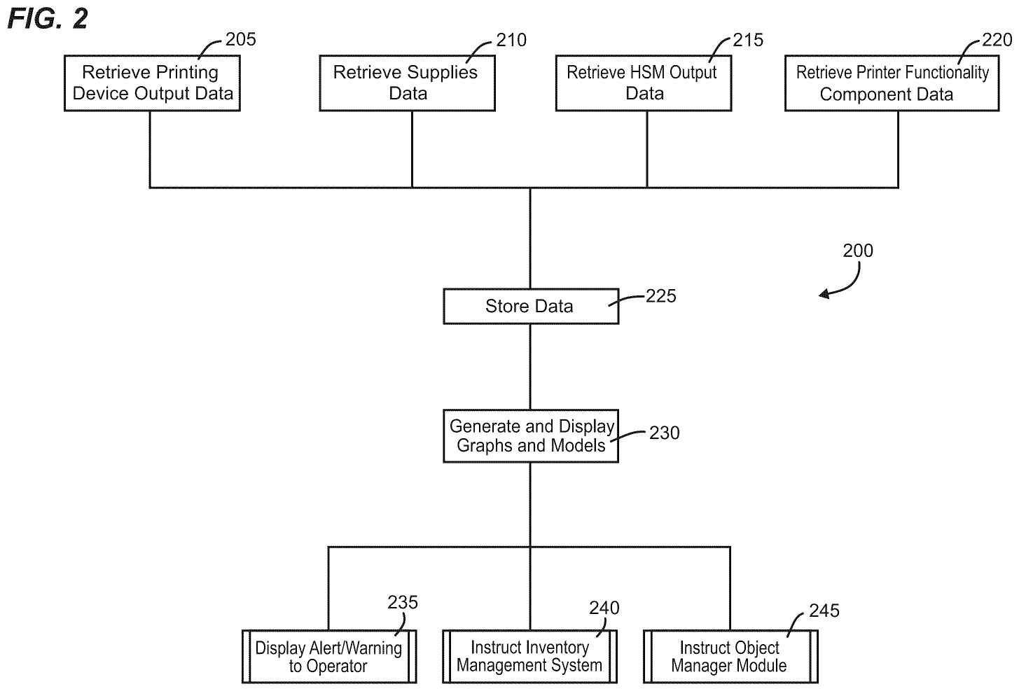

FIG. 2 illustrates a flowchart of a method 200 for providing production analytics of a printing architecture (e.g., the printing architecture 100 shown in FIG. 1) that includes one or more printing devices, according to one embodiment. The method 200 can be used, for example, with the printing architecture 100 shown in FIG. 1. The method 200 concurrently starts at 205, 210, 215 and 220.

At 205, an operator management device (e.g., the operator management device 190 shown in FIG. 1) continuously retrieves printing device output data. In some embodiments, the printing device output data can include data regarding each of the printing devices. This can include (for each of the printing devices): a current view indicating an online or offline status of each of the printing devices, how many personalization documents are being produced by each of the printing devices for a particular job, what type of personalization document is being created by each of the printing devices, a response time for producing the personalization document for each of the printing devices, the number of personalization documents rejected by the printing devices as unusable, an availability percentage of each of the printing devices, a performance percentage of each of the printing devices, a quality percentage of each of the printing devices, total number of personalization documents produced by each of the printing devices, a production time for producing the personalization documents for each of the printing devices, a production rate (e.g., personalization documents per hour) for each of the printing devices, a production rate (e.g., personalization documents per hour) for the printing architecture, an availability percentage of each of the printing devices, a performance percentage of the printing architecture, a quality percentage of the printing architecture, total number of personalization documents produced by the printing architecture, a printing device status for each of the printing devices, a production progress (e.g., cumulative total, hourly total, etc.) of the printing architecture, an hourly output of personalization documents produced by the printing architecture, a number of personalization documents produced by personalization document setup, a number of personalization documents produced by job setup, an operational comparison of different personalization document setups and operators based on a quality percentage, total personalization document production, a personalization document production time, a personalization document production rate, a number of rejected personalization documents (e.g., by printer functionality component, by printing device, by printing architecture, etc.), etc.

At 210, the operator management device continuously retrieves supplies data. In some embodiments, the supplies data can include data regarding supplies used for each of the printing devices. This can include (for each of the printing devices): indicating current supply levels of each of the printer functionality components, what type of supply is currently on each of the printer functionality components, and which of the supplies may be currently at or below a low-level threshold. In another example, the fleet management GUI can display a historical view indicating how much supply has been used for each of the printer functionality components over a set time period (e.g., the last week, the last month, the last six months, the last year, etc.), how much supply was used for each type of personalization document produced, how much supply material is applied to each personalization document, a wastage amount indicating how much material was left on each supply when switched out, a wastage amount indicating how much material is wasted in between producing each personalization document, etc. In some embodiments, the fleet management GUI can use the printing device output data and the supplies data to display a detailed breakdown of when each supply was removed from a printer functionality component (e.g., when the supply was removed, who removed the supply, a percentage of material left on the supply when removed, etc.); etc.

At 215, the operator management device continuously retrieves HSM output data. In some embodiments, the HSM output data can include data regarding each of the HSMs 170, HSM Servers 162/172 and/or each of the load balancing pools 175. This can include: performance and status data for each of the HSMs 170 and/or HSM Servers 162/172; availability data for each of the HSMs 170 and/or HSM Servers 162/172; a percentage load on each of the HSMs 170 and/or HSM Servers 162/172; a response time (e.g., speed) of each of the HSMs 170; the number of HSMs in each of the load balancing pools 175; the percentage load of each of the load balancing pools 175; performance and frequency data for granular, individual categories of cryptographic commands pers HSM 170 and/or HSM Servers 162/172 etc.

At 220, the operator management device continuously retrieves printer functionality component data. In some embodiments, the printer functionality component data can include data regarding performance status of each of the printer functionality components. This can include (for each of the printing devices): an online or offline status of each of the HSMs and/or HSM Servers, a percentage load on each of the HSMs, HSM Servers and/or load balancing pools, a response time (e.g., speed) of each of the HSMs, HSM Server and/or load balancing pools, a comparison of usage across different HSMs, HSM Servers and/or across different load balancing pools, etc. In some embodiments, the fleet management GUI can use the HSM output data to display a detailed breakdown of any errors on any of the HSMs, HSM Servers and/or load balancing pools (e.g., the number of errors, what kind of error occurred, which HSM, or HSM Server or load balancing pool incurred the error; performance and frequency data for granular, individual categories of cryptographic commands per HSM and/or HSM Servers, etc. In some embodiments, the printer functionality component data can be data regarding a subcomponent of the printer functionality component. For example, if the printer functionality component is a print head with one or more heating elements, the network input/output can provide performance and status data of each of the heating elements.

The method 200 then proceeds to 225.

At 225, the operator management device stores the retrieved printing device output data, the supplies data, the HSM output data and the printer functionality component data. In some embodiments, the operator management device can store the retrieved printing device output data, the supplies data, the HSM output data and the printer functionality component data in a memory or database of the operator management device. In other embodiments, the operator management device can store the retrieved printing device output data, the supplies data, the HSM output data and the printer functionality component data in a memory or database external to the operator management device. The method 200 proceeds to 230.

At 230, the operator management device and a fleet management GUI (e.g., the fleet management GUI 195 shown in FIG. 1) combine the retrieved printing device output data, the supplies data, the HSM output data and the printer functionality component data to generate graphs and models regarding the overall health of the printing architecture and displays the graphs and models on the fleet management GUI 195.

In some embodiments, the fleet management GUI includes a dashboard that allows an operator to view, in real time, how each of the printing devices (e.g., the printing devices 101 shown in FIG. 1) and how each of the HSMs (e.g., the HSMs 170 shown in FIG. 1) are operating to provide the operator with an overall health of the printing architecture. In some embodiments, the fleet management GUI can be a browser-based GUI accessible to the operator via the operator management device. In some embodiments, the operator management device can be part of the printing device (for example, when the printing device is a central card issuance system) and the fleet management can be displayed on the display (e.g., the display 117 shown in FIG. 1) of the printing device.

In some embodiments, the fleet management GUI can display various graphs and models to provide the operator an overall view of the health of the printing architecture. Based on the displayed data, an operator can draw correlations regarding the overall health of the printing architecture. For example, an operator can view displayed data regarding two or more of the printing device output data, the supplies data, the printer functionality component data, and HSM output data to determine an overall health of the printing architecture. Optionally, the fleet management GUI can display various graphs and models over time to monitor changes in operation (e.g., availability, performance, etc.) over a set time period (e.g., the last week, the last month, the last six months, the last year, etc.) or a desired time interval (e.g., between date x and date y; etc.). Examples of the graphs and models for display on the fleet management GUI are discussed above with respect to the fleet management GUI 195 shown in FIG. 1.

The method 200 proceeds concurrently to 235, 240 and 245.

At 235, the operator management device instructs the fleet management GUI to display various alerts or warnings based on the printing device output data, the supplies data, the HSM output data, and the printer functionality component data obtained at 205, 210, 215 and 220. In particular, as the operator management device 190 tracks the printing device output data, the supplies data, the HSM output data, and the printer functionality component data, the fleet management GUI 195 can display an alert or warning to the operator indicating an action may be required.

For example, the fleet management GUI can display an alert or warning when the operator management device determines that: one or more of the printing devices, the printer functionality components (e.g., the printer functionality components 105 shown in FIG. 1), the HSMs 170, HSM Servers 162/172 and/or the load balancing pools (e.g. the load balancing pools 175 shown in FIG. 1) is faulty or not operating properly; one or more of the printing devices is low on personalization documents; one or more of the printer functionality components is low on supply; one or more of the printing devices, the printer functionality components, the HSMs are operating below a desired percentage load threshold; one or more of the HSMs should be reassigned to another load balancing pool; one or more of the printing devices, the printer functionality components, the HSMs is approaching or operating past a warranty level, a recommended life and/or require replacement; etc.

At 240, the operator management device automatically sends instructions to an inventory management system to instruct the inventory management system to, for example, reload new personalization documents for printing, replace one or more supplies, replace one or more HSMs, etc. based on the retrieved printing device output data, the supplies data, the HSM output data and the printer functionality component data.

At 245, the operator management device automatically sends instructions to an object manager module (e.g., the object manager module 164 shown in FIG. 1) to automatically reconfigure the HSMs and or one or more load balancing pools (e.g., the load balancing pools 175 shown in FIG. 1). For example, the operator management device can use the retrieved printing device output data, the supplies data, the HSM output data, and/or the printer functionality component data to determine how each of the HSMs and the load balancing pools should be used. The operator management device and/or the fleet management GUI can then instruct the object manager module how to manage the HSMs and the load balancing pools based on the determination. This can include, for example, changing an online or offline status of one or more of the HSMs, moving one or more of the HSMs from one load balancing pool to another load balancing pool, etc.

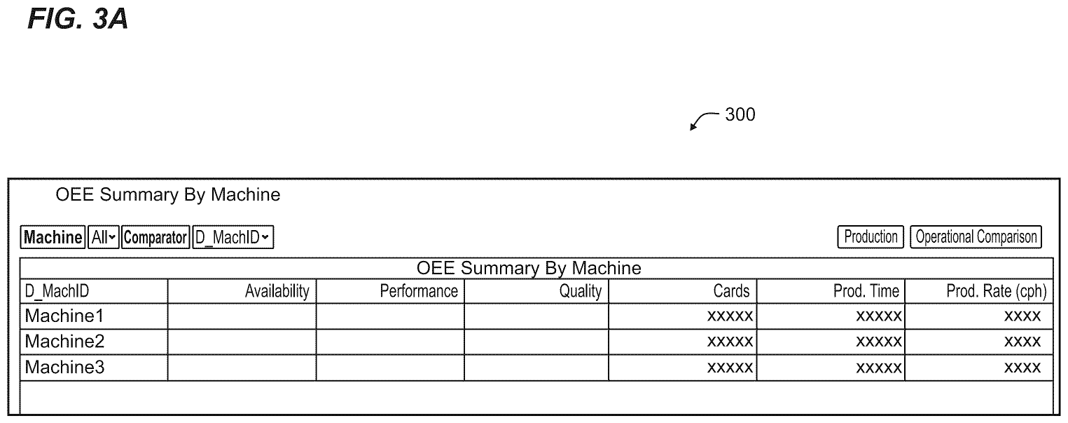

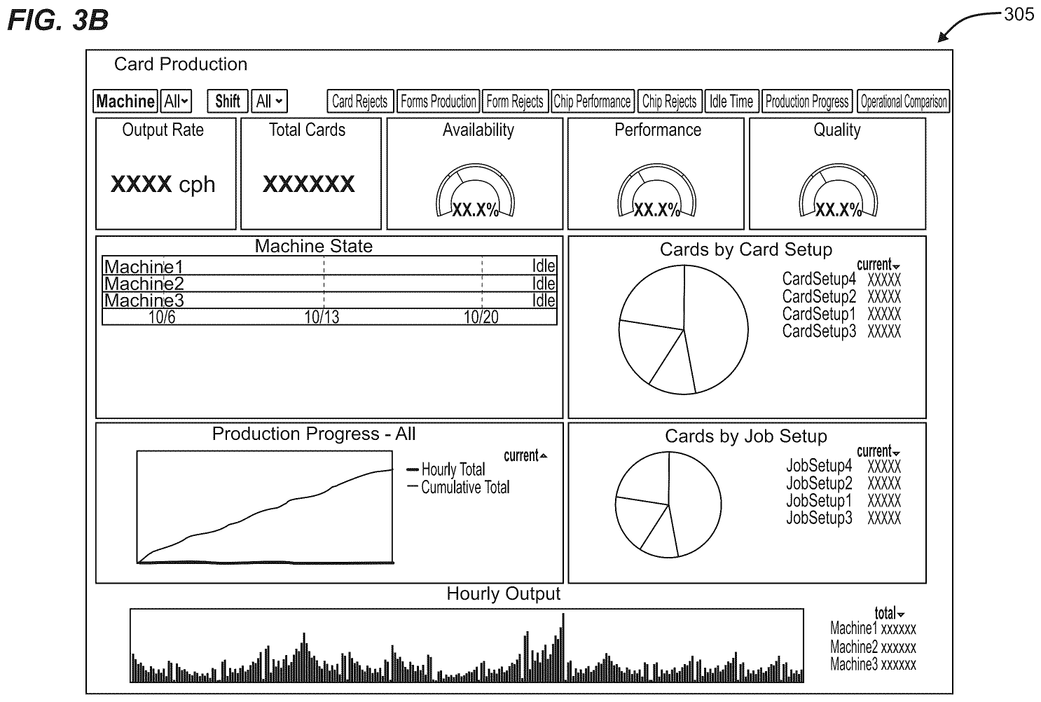

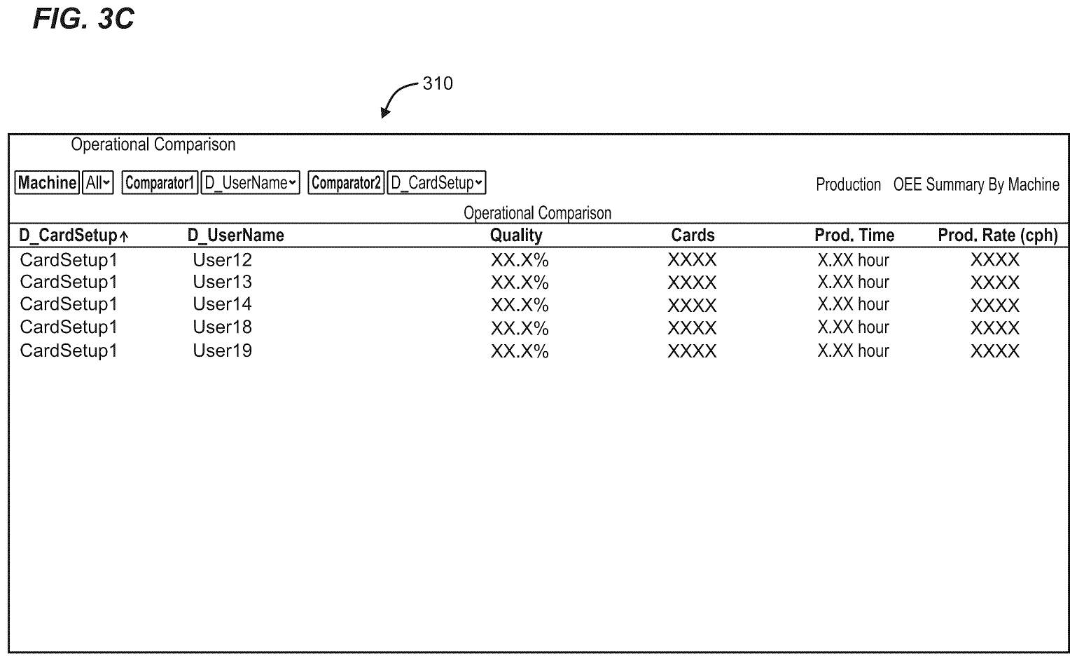

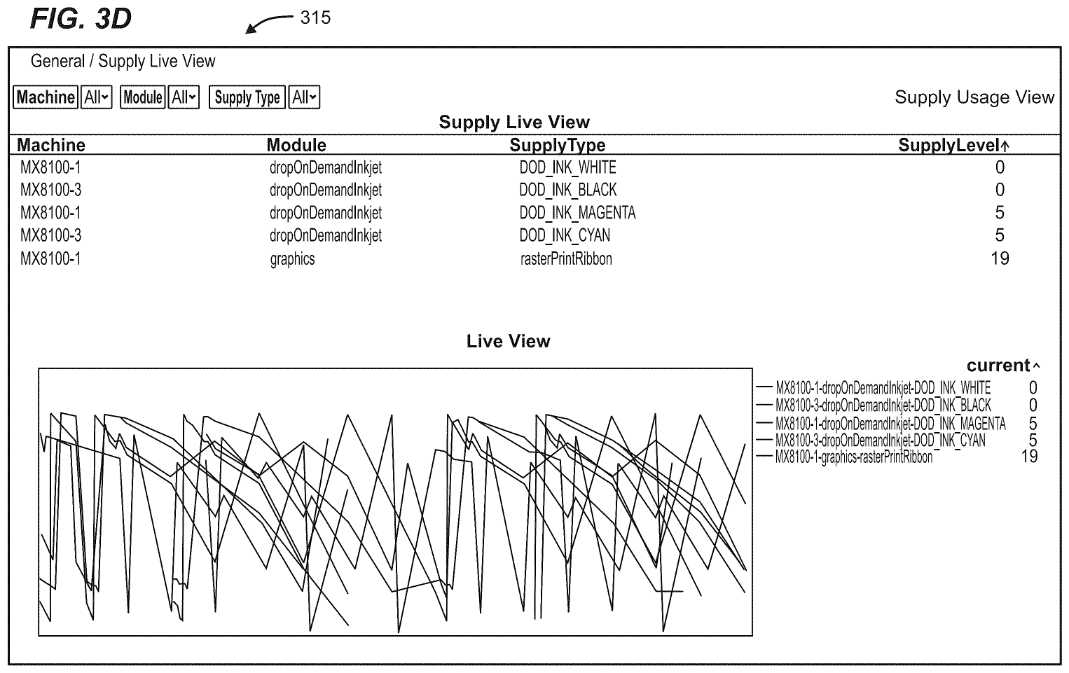

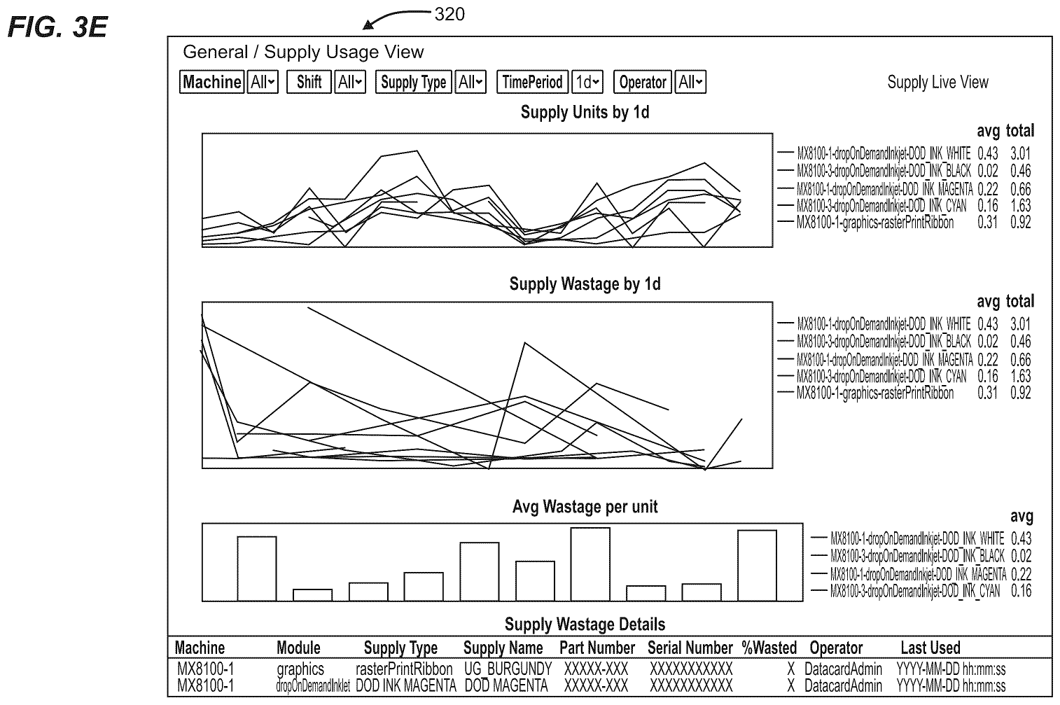

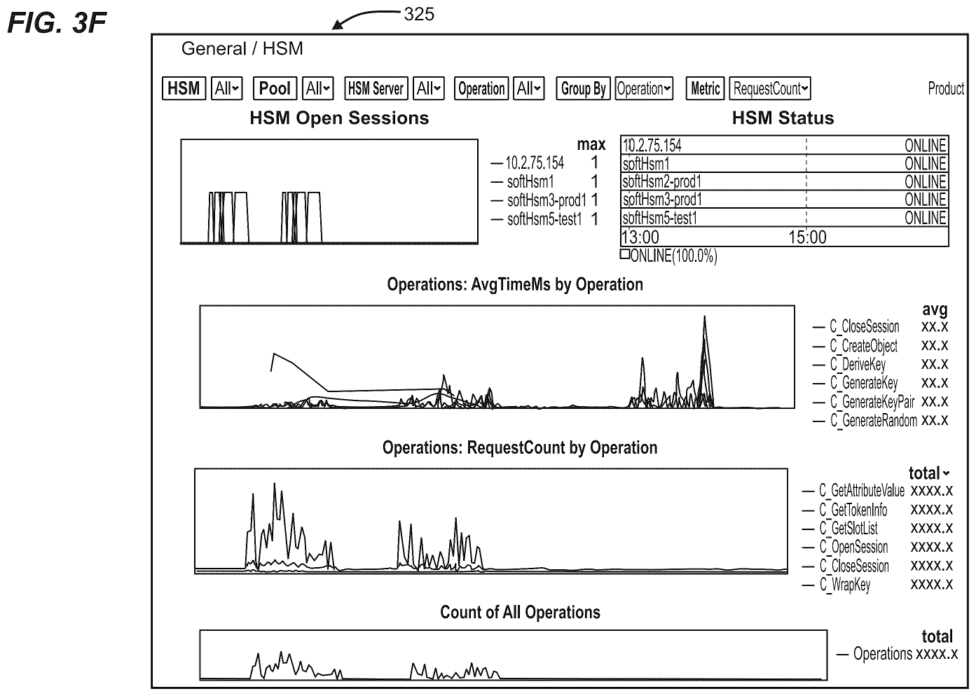

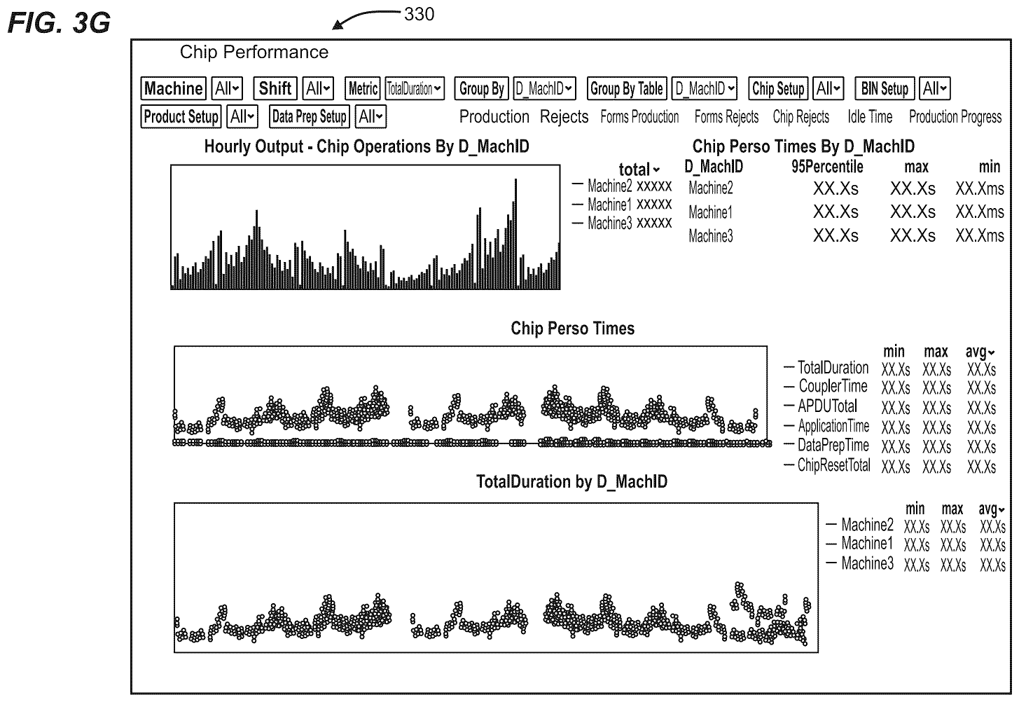

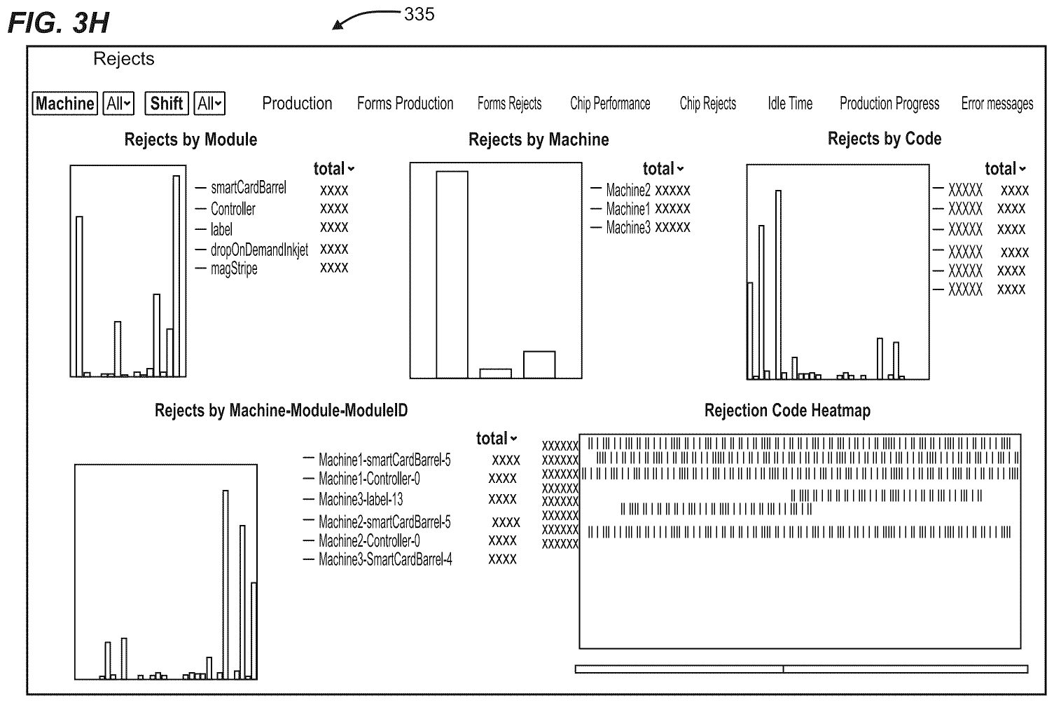

FIGS. 3A-3H illustrate different screenshots of a fleet management GUI, according to one embodiment. FIG. 3A illustrates a screenshot of a fleet management GUI 300 that displays performance summary of each of a plurality of printing devices. FIG. 3B illustrates a screenshot of a fleet management GUI 305 that displays performance summary of a printing architecture that includes a plurality of printing devices. FIG. 3C illustrates a screenshot of a fleet management GUI 310 that displays a performance comparison of different personalization document setups and different operators. FIG. 3D illustrates a screenshot of a fleet management GUI 315 that displays supplies data for a plurality of printer functionality components. FIG. 3E illustrates a screenshot of a fleet management GUI 320 that displays supplies usage and wastage of a plurality of different printer functionality components. FIG. 3F illustrates a screenshot of a fleet management GUI 325 that displays HSM performance summary of each of a plurality of HSMs. FIG. 3G illustrates a screenshot of a fleet management GUI 330 that displays printer functionality component performance summary of each of a plurality of printer functionality components. FIG. 3H illustrates a screenshot of a fleet management GUI 335 that displays personalization document rejects data for a plurality of printing devices.

Aspects described herein can be embodied as a system, method, or computer readable medium. In some embodiments, the aspects described can be implemented in hardware, software (including firmware or the like), or combinations thereof. Some aspects can be implemented in a computer readable medium, including computer readable instructions for execution by a processor. Any combination of one or more computer readable medium(s) can be used.

Some embodiments can be provided through a cloud-computing infrastructure. Cloud computing generally includes the provision of scalable computing resources as a service over a network (e.g., the Internet or the like).

Although a number of methods and systems are described herein, it is contemplated that a single system or method can include more than one of the above discussed subject matter. Accordingly, multiple of the above systems and methods can be used together in a single system or method.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method comprising:
interconnecting one or more central card issuance systems with an operator management device and one or more hardware security modules (HSMs) via a network;
retrieving data from each of the one more central card issuance systems, using the operator management device, the retrieved data comprising one or more of:
supply data regarding a supply used by each of the one or more central card issuance systems;
printer functionality component data regarding a printer functionality component included in each of the one or more central card issuance systems;
retrieving from each of the one or more HSMs, using the operator management device, HSM output data;
storing the retrieved data from the one more central card issuance systems and the HSM output data;
using the retrieved data and the HSM output data to generate health data; and
displaying the health data on a display via a graphical user interface (GUI).

2. The method of claim 1, wherein the retrieved data comprises the supply data and the printer functionality component data.

3. The method of claim 1, wherein the printer functionality component in each of the one or more central card issuance systems comprises a print head and the printer functionality component data comprises print head data.

4. The method of claim 1, wherein the printer functionality component comprises: a printer; an embosser; a laminator; a chip programming station; or a magnetic stripe station.

5. The method of claim 1, wherein the supply comprises a print ribbon; an ink; a laminate; or a foil.

6. The method of claim 1, comprising interconnecting a plurality of the central card issuance systems with the operator management device via the network.

7. The method of claim 1, further comprising interconnecting a personalization server with the one or more central card issuance systems, the operator management device, and the one or more HSMs via the network.

8. The method of claim 1, comprising incorporating the one or more HSMs as part of a primary object management site that includes a user interface, an object manager and an HSM server.

9. The method of claim 8, further comprising interconnecting a secondary object management site with the one or more central card issuance systems, the operator management device, and the one or more HSMs via the network; the secondary object management site comprising a user interface, an additional HSM, and an additional HSM server.

10. A printing architecture comprising:
one or more central card issuance systems;
a plurality of hardware security modules (HSMs) interconnected with the one or more central card issuance systems via a network, the HSMs are configured to perform a cryptographic operation for the one or more central card issuance systems; and
an operator management device interconnected with the one or more central card issuance systems and with the HSMs via the network, the operator management device includes a fleet management graphical user interface (GUI), wherein the operator management device is configured to retrieve data from each of the one or more central card issuance systems and retrieve HSM output data from the HSMs;
wherein the operator management device is also configured to store the retrieved data from each of the one or more central card issuance systems and store the retrieved HSM output data,
wherein the operator management device is configured to use the retrieved data from each of the one or more central card issuance systems and the retrieved HSM output data to generate health data of the printing architecture, and
wherein the fleet management GUI is configured to display the health data on a display.

11. The printing architecture of claim 10, wherein each of the one or more central card issuance systems includes a printer functionality component and a supply, and the retrieved data from each of the one or more central card issuance systems comprises printer functionality component data regarding the printer functionality component and supply data regarding the supply.

12. The printing architecture of claim 11, wherein the printer functionality component comprises: a printer; a print head; an embosser; a laminator; a chip programming station; or a magnetic stripe station.

13. The printing architecture of claim 11, wherein the supply comprises a print ribbon; an ink; a laminate; or a foil.

14. The printing architecture of claim 10, further comprising a personalization server that is interconnected with the one or more central card issuance systems, the operator management device, and the HSMs via the network.

15. The printing architecture of claim 10, wherein the HSMs are incorporated into a primary object management site that also includes a user interface, an object manager and an HSM server.

16. The printing architecture of claim 15, further comprising a secondary object management site interconnected with the one or more central card issuance systems, the operator management device, and the primary object management site via the network; the secondary object management site comprising a user interface, an additional HSM, and an additional HSM server.

17. A method comprising:
interconnecting a central card issuance system and an operator management device via a network;
retrieving, using the operator management device, first supply data regarding a supply used by a first printer functionality component of the central card issuance system;
retrieving, using the operator management device, second supply data regarding a supply used by a second printer functionality component of the central card issuance system;
storing the first supply data and the second supply data;
generating, using the operator management device, health data of the supply used by the first printer functionality component and of the supply used by the second printer functionality component; and
displaying the health data on a display via a graphical user interface (GUI).

18. The method of claim 17, further comprising:
interconnecting a plurality of hardware security modules (HSMs) with the central card issuance system and the operator management device via the network; and
retrieving, using the operator management device, HSM output data regarding each of the HSMs.

19. The method of claim 17, wherein one of the first printer functionality component and the second printer functionality component comprises: a printer; a print head; an embosser; a laminator; a chip programming station; or a magnetic stripe station.

20. A method comprising:
interconnecting one or more central card issuance system and an operator management device via a network;
retrieving, using the operator management device, supplies data regarding supplies used by each of the one or more central card issuance systems;
retrieving, using the operator management device, chip programming data of a chip programming component of at least one of the one or more central card issuance systems, the chip programming data including a programming speed of the chip programming component;
storing the supplies data and the chip programming data;
using the supplies data and the chip programming data to generate health data; and
displaying the health data on a display via a graphical user interface (GUI).
